(19) United States
(12) Patent Application Publication
(10) Pub. No.: US 2015/0220815 A1
(43) Pub. Date: Aug. 6, 2015

(54) IMAGE FORMING APPARATUS AND IMAGE FORMING METHOD

(71) Applicant: Chiaki AKIYAMA, Kanagawa (JP)

(72) Inventor: Chiaki AKIYAMA, Kanagawa (JP)

(21) Appl. No.: 14/602,845

(22) Filed: Jan. 22, 2015

(30) Foreign Application Priority Data
Feb. 6, 2014 (JP) 2014-021711

(51) Int. Cl. G06K 15/00; H04N 1/21; G06F 3/12; H04N 1/00

(52) U.S. Cl. CPC G06K 15/005; H04N 1/00408; H04N 1/21; G06F 3/1204; G06F 3/1219; G06F 3/1221; H04N 2201/0094

(57) ABSTRACT

An image forming apparatus comprises: an acquiring unit that acquires a target value of an achievement objective to contribute to at least one of environment and reduction in total cost of ownership; an extracting unit that extracts one or more print settings, in each of which an achievement expected value meets the target value, based on correspondence information indicating a correspondence relation between a plurality of different print settings and achievement expected values of the achievement objective expected when the respective print settings are applied to printing; and a displaying unit that displays setting information indicating the one or more print settings extracted by the extracting unit.

### CROSS-REFERENCE TO RELATED APPLICATIONS

The present application claims priority to and incorporates by reference the entire contents of Japanese Patent Application No. 2014-021711 filed in Japan on Feb. 6, 2014.

### BACKGROUND OF THE INVENTION

1. Field of the Invention

The present invention relates to an image forming apparatus, and an image forming method.

2. Description of the Related Art

When printing documents via a personal computer (PC), it is common to display, as a preview, the end result of printing on a screen of the PC and confirm or change print settings. It is well known that when a print setting, such as duplex printing or combined printing, for saving the number of output sheets is made, a sheet usage reduction ratio is displayed on the screen to encourage saving of sheets in order to encourage a print setting effective for environment or reduction in total cost of ownership (TOC).

Japanese Patent No. 3943829 describes a print condition setting apparatus capable of easily setting print conditions when printing image data.

However, conventionally, it is difficult to know, in advance, information indicating how effective each print setting is or information indicating a combination of print settings for a certain effect. Therefore, it may be necessary to perform print setting again and again.

The present invention has been conceived in view of the above, and there is a need for an image forming apparatus, and an image forming method that can easily perform print setting that meets a target value of an achievement objective, which is to contribute to at least one of environment and reduction in the total cost of ownership, as desired by a user.

### SUMMARY OF THE INVENTION

It is an object of the present invention to at least partially solve the problems in the conventional technology.

There is provided an image forming apparatus that comprises an acquiring unit that acquires a target value of an achievement objective to contribute to at least one of environment and reduction in total cost of ownership; an extracting unit that extracts one or more print settings, in each of which an achievement expected value meets the target value, based on correspondence information indicating a correspondence relation between a plurality of different print settings and achievement expected values of the achievement objective expected when the respective print settings are applied to printing; and a displaying unit that displays setting information indicating the one or more print settings extracted by the extracting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a configuration diagram illustrating a configuration example of an image forming system;

FIG. 2 is a block diagram illustrating an overview of a program in a client terminal;

FIG. 3 is a functional block diagram illustrating functions of the program in the client terminal;

FIG. 4 is a flowchart illustrating an example of operation of the client terminal;

FIG. 5 is a diagram illustrating an example of a print dialog displayed by the client terminal;

FIG. 6 is a table illustrating an example of a correspondence table (correspondence information); and

FIG. 7 is a diagram illustrating the print dialog displayed by the client terminal to simplify a print setting that meets a target value of an achievement objective desired by a user.

### DETAILED DESCRIPTION OF THE PREFERRED EMBODIMENTS

### Embodiment

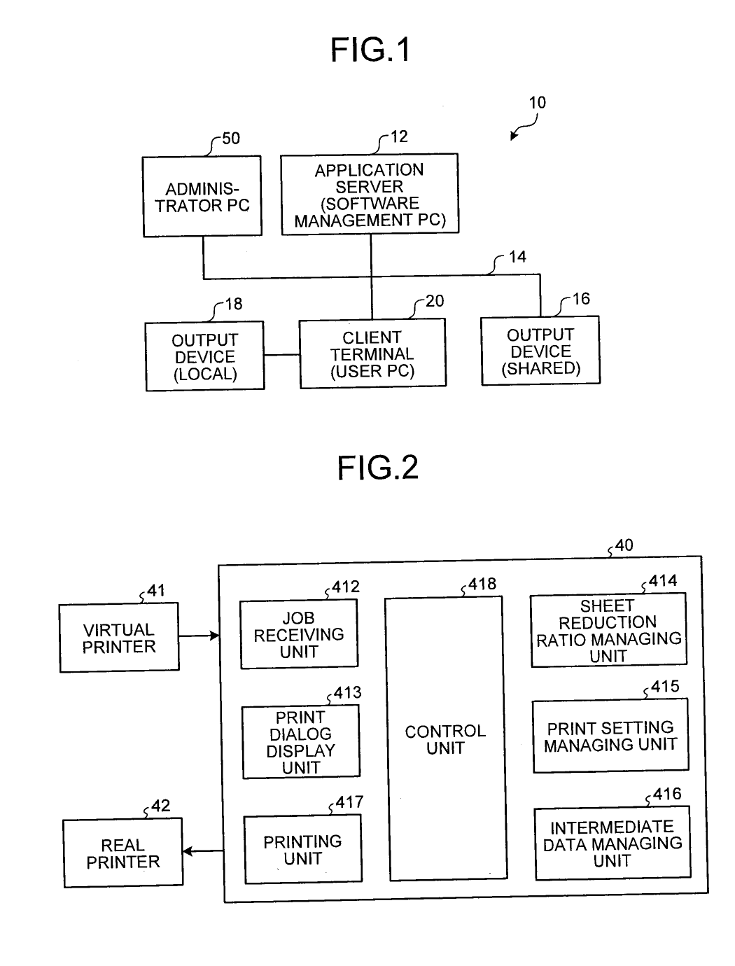

Exemplary embodiments of an image forming system (network system) will be described in detail below with reference to the accompanying drawings. FIG. 1 is a configuration diagram illustrating a configuration example of an image forming system 10. As illustrated in FIG. 1, the image forming system 10 is a client-server system, in which an application server (software management PC) 12 is connected to an output device (shared) 16, an administrator PC 50, and a client terminal (user PC) 20 via a wired or wireless network 14. An output device (local) 18 is connected to the client terminal 20.

Each of the application server 12, the client terminal 20, and the administrator PC 50 is a computer (information processing apparatus) that operates by executing a computer program, and includes an input/output device, such as a keyboard and display or a touch panel. The administrator PC 50 is used by an administrator to perform setting on the client terminal 20 of a user. The application server 12 stores therein software (a platform, a plug-in body, setting data, and the like) to be distributed to the client terminal 20. The administrator PC 50 and the application server 12 may be configured to be integrated.

The client terminal 20 is a terminal used by a user. The output device 16 is an image forming apparatus, such as a multifunction peripheral, that implements various functions according to settings. The output device 16 is available to (shared by) a plurality of the client terminals 20. The output device 18 is, for example, an image forming apparatus or the like that is locally connected to one of the client terminals 20 via wired or wireless communication.

The image forming system 10 does not necessarily have to be configured as described above, and may include a plurality of the application servers 12, the client terminals 20, and the output devices 16, for example.

Next, the client terminal 20 will be described in detail. FIG. 2 is a block diagram illustrating an overview of a program and the like in the client terminal 20. As illustrated in FIG. 2, the client terminal 20 includes, as software for example, an application 40 provided as a plug-in, a virtual printer 41, and a real printer 42.

The virtual printer 41 converts drawing data obtained from a printing application (not illustrated) to image data (for example, EMF, Bitmap, XPS, or the like) independent from a printer driver, and stores the image data as a file in a storage device (not illustrated) in the client terminal 20. The virtual printer 41 also stores therein, for example, information indicating a print setting of the output device 16, together with the image data.

The application 40 includes a job receiving unit 412, a print dialog display unit 413, a sheet reduction ratio managing unit 414, a print setting managing unit 415, an intermediate data managing unit 416, a printing unit 417, and a control unit 418.

The job receiving unit 412 communicates with the virtual printer 41 and receives a job event, such as a job start and a job end, and intermediate data generated by the virtual printer 41.

The control unit 418 controls job processing performed by the application 40, and sends a job received from the job receiving unit 412 to the print dialog display unit 413 and the printing unit 417.

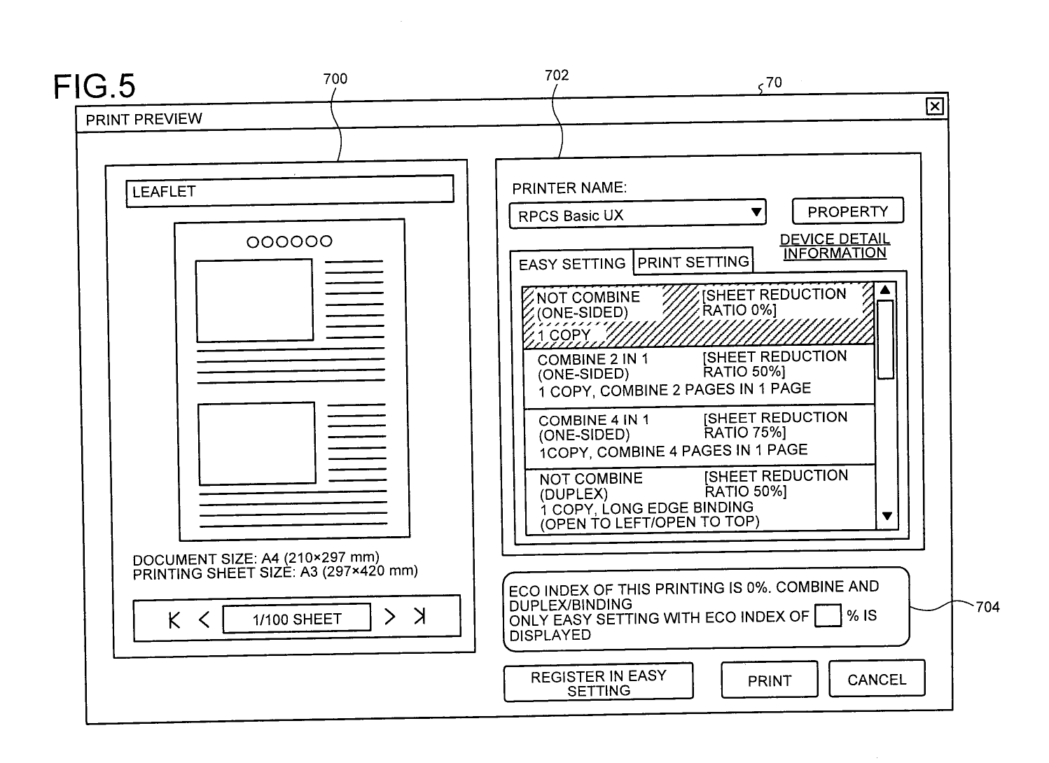

The print dialog display unit 413 displays a print dialog (see FIG. 5) to be described later. The sheet reduction ratio managing unit 414 calculates and stores therein a sheet reduction ratio according to a print setting to be described later. The print setting managing unit 415 performs a process of storing or changing the print setting, for example. The intermediate data managing unit 416 stores therein intermediate data or the like.

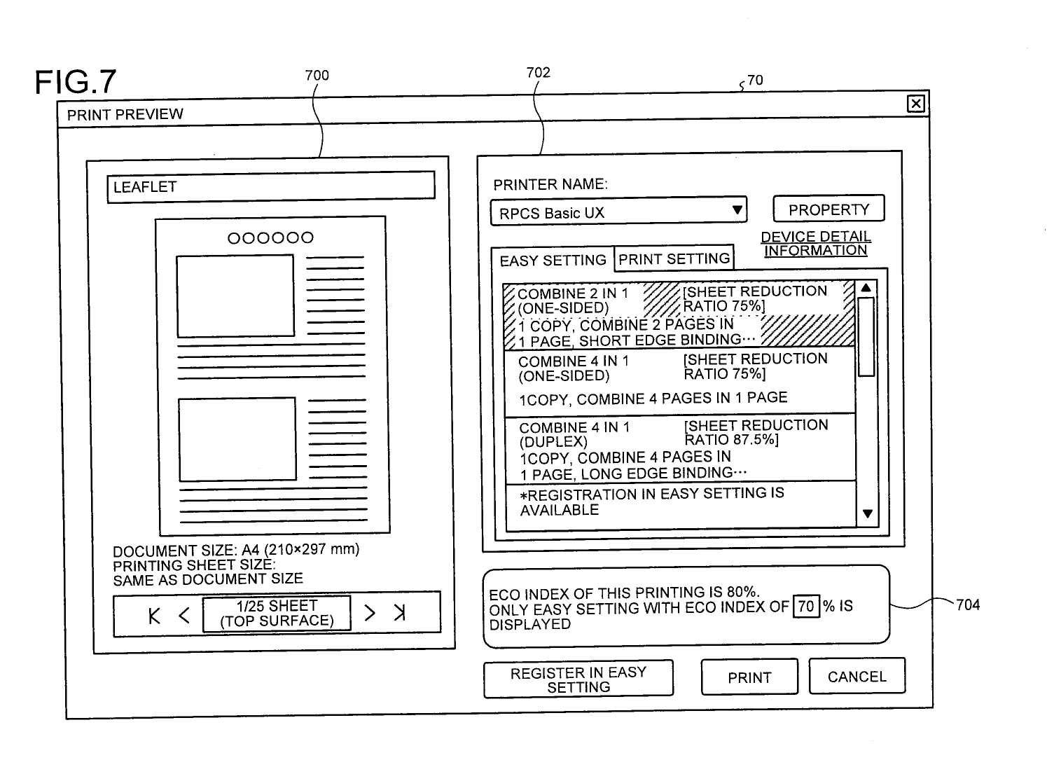

The printing unit 417 outputs a request to print intermediate data to the real printer 42. The printing unit 417 applies a print setting set on the print dialog (see FIG. 7).

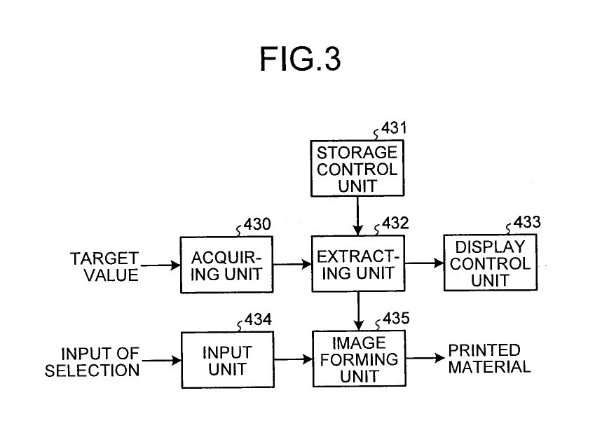

FIG. 3 is a functional block diagram illustrating an example of functions of a program in the client terminal 20. Each of the functions illustrated in FIG. 3 does not necessarily have to be provided in the client terminal 20, and may be provided in the output device 16 or in the client terminal 20 and the output device 16 in a distributed manner.

An acquiring unit 430 acquires a target value of an achievement objective to contribute to at least one of environment and reduction in total cost of ownership, via an input device of the client terminal 20 or the like. The achievement objective is, for example, an objective to reduce at least one of recording media, such as sheets, used for printing, toner, electricity, and an amount of CO₂ emission due to printing.

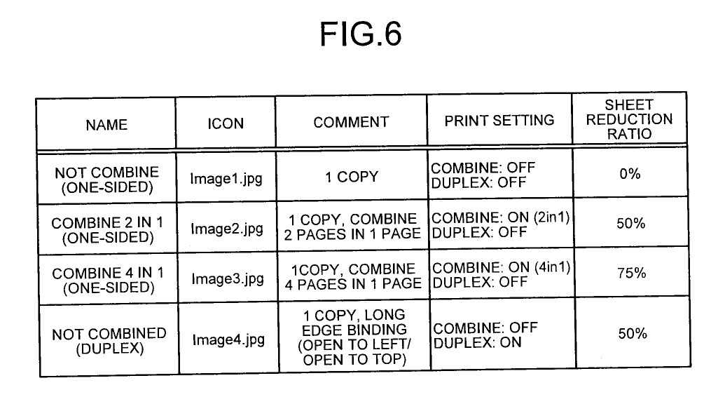

A storage control unit 431 stores, in the storage device (storage unit) in the client terminal 20 or the like, correspondence information indicating a correspondence relation between a plurality of different print settings and achievement expected values of the achievement objective expected when the respective print settings are applied to printing. respective print settings are applied to printing. Here, the correspondence relation is indicated by a correspondence table (to be described later with reference to FIG. 6) stored in the storage device.

An extracting unit 432 extracts one or more print settings, in each of which the achievement expected value meets the target value, based on the above described correspondence information.

A display control unit 433 displays setting information indicating the one or more print settings extracted by the extracting unit 432 on an output device (display unit) in the client terminal 20 for example.

An input unit 434 receives, from the user, an input of selection of any of the one or more print settings indicated by the setting information displayed by the display control unit 433, via an input device in the client terminal 20 for example.

An image forming unit 435 performs printing based on any of the one or more print settings extracted by the extracting unit 432 in response to the input received by the input unit 434, and outputs a printed material via the output device 16 for example.

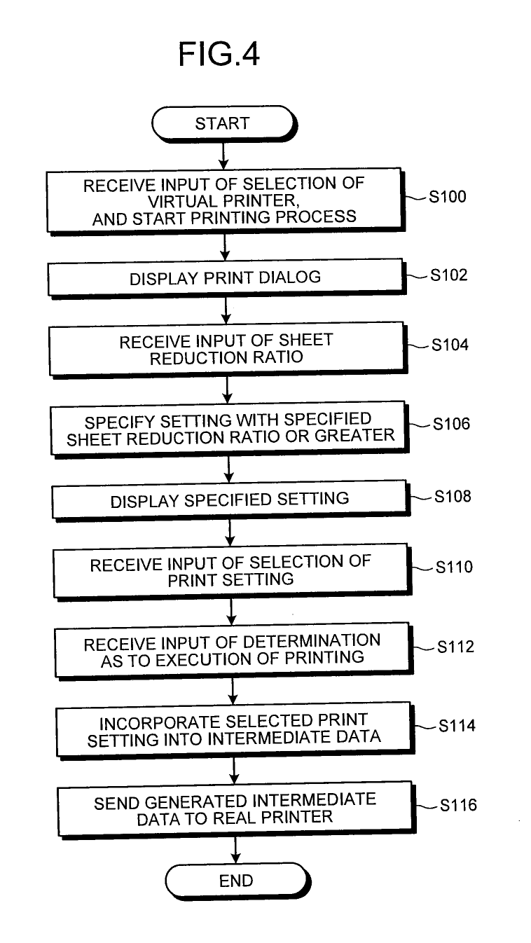

Next, an example of operation of the client terminal 20 will be described. FIG. 4 is a flowchart illustrating an example of the operation of the client terminal 20. As illustrated in FIG. 4, at Step S100, the client terminal 20 receives an input of selection of a virtual printer via the printing application, and starts a printing process.

At Step S102, the client terminal 20 displays a print dialog to be described later with reference to FIG. 5.

At Step S104, the client terminal 20 receives an input of a target value of a sheet reduction ratio, as an example of the achievement objective, desired by the user. Here, the acquiring unit 430 acquires the target value.

At Step S106, the client terminal 20 specifies a print setting (setting), in which a sheet reduction ratio equal to or grater than the sheet reduction ratio specified by the user is expected. The extracting unit 432 extracts a print setting, in which the achievement expected value meets the target value, based on the above described correspondence information. If a plurality of print settings in which the achievement expected value meets the target value are present, all of the print settings are displayed in a selectable manner.

At Step S108, the client terminal 20 displays the print setting specified in the process at Step S106 on an output device (display or the like). Here, the display control unit 433 displays the print setting via the output device.

At Step S110, the client terminal 20 receives an input of selection of a print setting from the user. Here, the input unit 434 receives the input of selection from the user.

At Step S112, the client terminal 20 receives an input of determination as to execution of printing from the user.

At Step S114, the client terminal 20 causes the image forming unit 435 to incorporate the print setting selected by the user into intermediate data to generate the intermediate data for example.

At Step S116, the client terminal 20 causes the image forming unit 435 to send the generated intermediate data to a real printer 46, for example.

Next, the print dialog displayed by the client terminal 20 and acquisition of the target value of the achievement objective will be described in detail. FIG. 5 is a diagram illustrating an example of a print dialog 70 displayed by the client terminal 20. The print dialog 70 includes a preview image 700, a print setting UI (print setting input unit) 702, and a sheet reduction ratio setting UI (sheet reduction ratio setting input unit) 704.

The preview image 700 represents a preview after printing by using page imposition reflecting the print setting, a line indicating the position of duplex binding, and the like, in accordance with image data of the intermediate data and the print setting.

The print setting UI 702 displays a list of a plurality of print settings (items as combinations of a plurality of print settings) to allow the user to select a print setting. For example, the print setting UI 702 displays a plurality of print settings in a selectable manner so that a combination of print settings that may be frequently used by the user can be applied by single operation.

The sheet reduction ratio setting UI 704 includes a display area (displayed as an eco index in FIG. 5) for displaying a sheet reduction ratio expected to be achieved by the currently-set print setting, and an input area (an area for inputting the eco index in FIG. 5) for inputting a target value of a sheet reduction ratio desired by the user. When the target value of the sheet reduction ratio desired by the user is input in the input area of the sheet reduction ratio setting UI 704, the acquiring unit 430 acquires the target value of the sheet reduction ratio as the target value of the achievement objective.

When the acquiring unit 430 acquires the target value, the display control unit 433 displays only print settings (items as combinations of print settings), each of which meets the target value (each of which has the input sheet reduction ratio or greater), on the print setting UI 702.

The client terminal 20 stores the print setting and the achievement objective, such as the sheet reduction ratio or the like, in the storage device in the form of the correspondence table (correspondence information), for example. FIG. 6 is a table illustrating an example of the correspondence table (correspondence information). As illustrated in FIG. 6, the correspondence table contains, for example, a name of a print setting, an icon (image), a comment, a print setting, and a sheet reduction ratio in an associated manner.

The print setting defines a print setting item, such as Print Ticket, and a setting value of the print setting item in the XML format. However, descriptions, definitions, setting contents of the print setting are not limited to those as described above.

Next, a method of calculating a sheet reduction ratio as a specific example of the achievement objective will be described in detail. A sheet reduction ratio for a currently-set print setting is calculated by using the currently-set print setting and the number of pages to be printed.

For example, the sheet reduction ratio contained in the correspondence table is a value indicating how many sheets are reduced when a print setting for reducing the number of pages to be printed is performed, relative to the number of sheets to be output when the print setting for reducing the number of pages to be printed is not performed.

However, in this method, the sheet reduction ratio contained in the correspondence table and the sheet reduction ratio obtained after actual printing may not match each other. For example, when a sheet reduction ratio of a print setting for duplex printing is set to 50% in the correspondence table, and if a document of four pages is printed by duplex printing, the number of sheets is two, thereby resulting correctly in the sheet reduction ratio of just 50%. However, the number of sheets is also two even when a document of three pages is printed by duplex printing. Namely, when the document of three pages is printed by duplex printing, the sheet reduction ratio becomes 33.3%.

Further, if a document size of the first page differs from that of the second page, one-side printing may be performed on two sheets even when duplex printing is set in the image forming apparatus. In this case, a result differs from the sheet reduction ratio defined in advance in the correspondence table. Therefore, the client terminal 20 may be configured to calculate a sheet reduction ratio by using the number of pages of print data, a sheet size, and orientation of a sheet, rather than using the sheet reduction ratio contained in the correspondence table.

As the print setting for reducing the number of pages to be printed, the print settings for combined printing and duplex printing are described by way of example; however, it is not limited thereto. For example, the print setting may be a setting for reducing output sheets by a blank sheet suppression setting, weekly magazine printing, or the like. Further, the image forming system 10 may be configured to improve contribution to environment by allowing switching of the recording media, such as sheets, to recycled papers.

Furthermore, in the embodiment, the sheet reduction ratio is described as an example of the achievement objective to contribute to at least one of environment and reduction in the total cost of ownership; however, it is not limited thereto. For example, the image forming system 10 may determine the achievement objective by using a sheet usage rate due to reduction in a sheet size, a toner usage rate, or a combination of these rates. Moreover, the achievement objective may be the amount of electricity or the amount of CO₂ emission to be reduced by changing a print condition. For example, it may be possible to calculate the amounts of reduction in electricity and CO₂ emission corresponding to a target value and include the amounts of reduction in the correspondence table in advance, and, if the achievement expected value is 50%, the client terminal 20 may display information indicating that the amount of reduction in electricity is expected to be 50% based on the correspondence table. Furthermore, the client terminal 20 may display the amount of reduction in electricity and the amount of reduction in CO₂ emission separately or in combination. Consequently, the user can specifically check the amount of reduction in electricity and the amount of reduction in CO₂ emission, so that the effect of reduction becomes clear and the possibility to select a print output with the target value may be increased.

Next, the print dialog 70 to be displayed when the client terminal 20 sets the print setting that meets a target value of an achievement objective desired by the user will be described. FIG. 7 is a diagram illustrating the print dialog 70 displayed by the client terminal 20 to simplify a print setting that meets the target value of the achievement objective desired by the user.

In the example illustrated in FIG. 7, the user specifies the sheet reduction ratio of 70%. In this case, the print setting UI 702 displays only print settings, in each of which a sheet reduction ratio of 70% or grater is expected, in a selectable manner.

As described above, the image forming system 10 extracts print settings, in each of which the achievement expected value meets the target value, based on the correspondence information indicating a correspondence relation between a plurality of different print settings and the achievement expected values of the achievement objective expected to be obtained when the respective print settings are applied to printing. Therefore, it becomes possible to easily enable a print setting that meets the target value of the achievement objective, which is to contribute to at least one of environment and reduction in total cost of ownership, as desired by the user.

Further, the image forming system 10 enables an administrator to distribute a print setting to be installed or set in a device such as the client terminal 20, a computer program containing the print setting, or the like, and thereafter manage whether the client terminal 20 completes the print setting.

Each of the client terminal 20, the administrator PC 50, and the software management PC 12 of the embodiment includes a control device, such as a CPU, a storage device, such as a read only memory (ROM) or a random access memory (RAM), an external storage device, such as a hard disk drive (HDD) or a compact disk (CD) drive device, a display device, such as the above described display device, and an input device, such as a keyboard or a mouse, and has a hardware configuration using a normal computer. An image forming program executed by the client terminal 20, the administrator PC 50, and the software management PC 12 of the embodiment is provided by being recorded in a computer-readable storage medium, such as a CD-ROM, a flexible disk (FD), a CD-R, or a digital versatile disk (DVD), in a computer-installable or computer-executable file format.

Further, the image forming program executed by the client terminal 20, the administrator PC 50, and the software management PC 12 of the embodiment may be stored in a computer connected to a network, such as the Internet, and provided by being downloaded via the network. Furthermore, the image forming program executed by the client terminal 20, the administrator PC 50, and the software management PC 12 of the embodiment may be provided or distributed via a network, such as the Internet. Moreover, the image forming program of the embodiment may be provided by being incorporated in a ROM or the like in advance.

According to an embodiment of the present invention, it is possible to easily enable a print setting that meets the target value of the achievement objective, which is to contribute to at least one of environment and reduction in total cost of ownership, as desired by the user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cashe memory of the CPU, and the RAM may function as a physical memory or a primary memory of the apparatus, while the HDD may function as a secondary memory of the apparatus.

What is claimed is:

1. An image forming apparatus comprising:
an acquiring unit that acquires a target value of an achievement objective to contribute to at least one of environment and reduction in total cost of ownership;
an extracting unit that extracts one or more print settings, in each of which an achievement expected value meets the target value, based on correspondence information indicating a correspondence relation between a plurality of different print settings and achievement expected values of the achievement objective expected when the respective print settings are applied to printing; and
a displaying unit that displays setting information indicating the one or more print settings extracted by the extracting unit.

2. The image forming apparatus according to claim 1, further comprising:
an input unit that receives an input of selection of any of the one or more print settings indicated by the setting information displayed by the displaying unit; and
a printing unit that performs printing based on any of the one or more print settings extracted by the extracting unit in response to the input received by the input unit.

3. The image forming apparatus according to claim 1, wherein the correspondence information indicates the correspondence relation by a table stored in a storage unit.

4. The image forming apparatus according to claim 1, wherein the achievement objective is an objective to reduce at least one of recording media used for printing, toner, electricity, and an amount of CO₂ emission due to printing.

5. An image forming method comprising:
acquiring a target value of an achievement objective to contribute to at least one of environment and reduction in total cost of ownership;
extracting one ore more print settings, in each of which an achievement expected value meets the target value, based on correspondence information indicating a correspondence relation between a plurality of different print settings and achievement expected values of the achievement objective expected when the respective print settings are applied to printing;
displaying setting information indicating the one or more print settings extracted at the extracting;
receiving an input of selection of any of the one or more print settings indicated by the setting information displayed at the displaying; and
performing printing based on any of the one or more print settings extracted at the extracting in response to the input received at the receiving.

6. The image forming method according to claim 5, further comprising:
receiving an input of selection of any of the one or more print settings indicated by the setting information displayed at the displaying; and
performing printing based on any of the one or more print settings extracted at the extracting in response to the input received at the receiving.

7. The image forming method according to claim 5, wherein the correspondence information indicates the correspondence relation by a table stored in a storage.

8. The image forming method according to claim 5, wherein the achievement objective is an objective to reduce at least one of recording media used for printing, toner, electricity, and an amount of CO₂ emission due to printing.
